(19) United States
(12) Patent Application Publication
(10) Pub. No.: US 2024/0186869 A1
(43) Pub. Date: Jun. 6, 2024

(54) METHOD OF MANUFACTURING MOTOR CORE

(71) Applicant: TOYOTA JIDOSHA KABUSHIKI KAISHA, Toyota-shi (JP)

(72) Inventor: Shuta NEGORO, Toyota-shi (JP)

(73) Assignee: TOYOTA JIDOSHA KABUSHIKI KAISHA, Toyota-shi (JP)

(21) Appl. No.: 18/480,093

(22) Filed: Oct. 3, 2023

(30) Foreign Application Priority Data
Dec. 5, 2022 (JP) 2022-194132

(51) Int. Cl. H02K 15/02

(52) U.S. Cl. CPC H02K 15/02; H02K 2213/03

(57) ABSTRACT

The manufacturing method includes a protrusion providing step, a crimping step, and a filling step. The protrusion providing step provides a hollow crimp protrusion in each of multiple electromagnetic steel sheets. In the crimping step, the electromagnetic steel sheets are laminated and loaded along a laminating direction, and the crimp protrusion of each of the adjacent electromagnetic steel sheets is crimp-fastened. The filling step fills an adhesive between the adjacent electromagnetic steel sheets. A hollow portion inside the crimp protrusion includes a side surface, a bottom surface, and an inclined surface. A depth A along the side surface of the hollow portion, a depth B of the bottom surface, and a sheet thickness T of each of the electromagnetic steel sheets satisfy the following (Equation 1) to (Equation 3).

1.2T≤B≤1.4T (Equation 1)

0.0T<A<1.4T (Equation 2)

A<B (Equation 3)

### CROSS-REFERENCE TO RELATED APPLICATION

This application claims priority to Japanese Patent Application No. 2022-194132 filed on Dec. 5, 2022, incorporated herein by reference in its entirety.

### BACKGROUND

### 1. Technical Field

The technology disclosed in the present specification relates to a method of manufacturing a motor core.

### 2. Description of Related Art

A motor core is made by laminating a plurality of electromagnetic steel sheets (for example, Japanese Patent No. 6779565 (JP 6779565 B)). The electromagnetic steel sheets adjacent to each other are connected to each other by crimp-fastening. The crimp-fastening is as follows. Each electromagnetic steel sheet is provided with a hollow protrusion. The electromagnetic steel sheets are laminated, and a load is applied along the laminating direction. The protrusion is pushed into a hollow portion of the protrusion of the adjacent electromagnetic steel sheet. The protrusion is fixed to the hollow portion while being plastically deformed. Thus, the electromagnetic steel sheets adjacent to each other are connected.

### SUMMARY

Connecting force may be insufficient only by the crimp-fastening. The present specification provides a method of manufacturing a motor core capable of strengthening a connection of electromagnetic steel sheets adjacent to each other with an adhesive in addition to crimp-fastening.

The method of manufacturing disclosed in the present specification includes a protrusion providing step, a crimping step, and a filling step. The protrusion providing step provides a hollow crimp protrusion in each of a plurality of electromagnetic steel sheets. In the crimping step, the electromagnetic steel sheets are laminated to apply a load along a laminating direction, and the crimp protrusion of each of the adjacent electromagnetic steel sheets is crimp-fastened. The filling step fills an adhesive between the adjacent electromagnetic steel sheets. Here, the inside (that is, a hollow portion) of the crimp protrusion includes a side surface perpendicular to a surface of each of the electromagnetic steel sheets, a bottom surface parallel to the surface of each of the electromagnetic steel sheets, and an inclined surface connecting the side surface and the bottom surface. A depth A along the side surface of the hollow portion, a depth B of the bottom surface, and a sheet thickness T of each of the electromagnetic steel sheets satisfy the following (Equation 1) to (Equation 3).

1.2T≤B≤1.4T (Equation 1)

0.0T<A<1.4T (Equation 2)

A<B (Equation 3)

When the depth A along the side surface of the hollow portion, the depth B of the bottom surface, and the sheet thickness T of the electromagnetic steel sheet satisfy the (Equation 1) to (Equation 3), a moderate gap remains between the electromagnetic steel sheets adjacent to each other at the end of the crimping step. By filling the gap with the adhesive, it is possible to manufacture a motor core with increased connecting force.

Details of the techniques disclosed in the present specification and further modifications will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of an electromagnetic steel sheet having a crimp protrusion;

FIG. 2 is a perspective view of the electromagnetic steel sheet having the crimp protrusion (rear surface of FIG. 1);

FIG. 3 is a sectional view of the electromagnetic steel sheet taken along line III-III in FIG. 2;

FIG. 4 is a sectional view illustrating a protrusion providing step (section corresponding to line III-III in FIG. 2);

FIG. 5 is a sectional view illustrating a protrusion providing step (section corresponding to V-V line in FIG. 2);

FIG. 6 is a view for explaining a crimp-fastening step; and

FIG. 7 is a diagram for explaining filling step.

### DETAILED DESCRIPTION OF EMBODIMENTS

A method of manufacturing of an embodiment will be described with reference to the drawings. The method of manufacturing of the embodiment is a method of manufacturing of a motor core. The “motor core” may be a rotor core or a stator core. In either case, the motor core is made by laminating a number of thin electromagnetic steel sheets.

A crimp-fastening is employed to connect adjacent electromagnetic steel sheets to each other. The crimp-fastening is as follows. Each electromagnetic steel sheet is provided with a crimp protrusion. In the plurality of electromagnetic steel sheets, crimp protrusions of the same size are formed at the same position. Typically, the crimp protrusion is formed by press working (punching) a flat electromagnetic steel sheet. The crimp protrusion is hollow. The outer diameter of the crimp protrusion is slightly larger than the inner diameter of the crimp protrusion. A plurality of electromagnetic steel sheets are laminated. A load is applied to the plurality of laminated electromagnetic steel sheets along the laminating direction. The crimp protrusion is strongly pushed into the hollow portion of the crimp protrusion of the adjacent electromagnetic steel sheet. The crimp protrusion is fixed to the hollow portion while being plastically deformed. In this way, adjacent electromagnetic steel sheets are connected.

In the method of manufacturing of the embodiment, in addition to the crimp-fastening, an adhesive is filled between adjacent electromagnetic steel sheets. Adjacent electromagnetic steel sheets are connected by both the connecting force of the crimp-fastening and the adhesive force of the adhesive. Since two types of connecting forces are applied, adjacent electromagnetic steel sheets are strongly connected. In the conventional crimp-fastening, a gap is not sufficiently left between adjacent electromagnetic steel sheets to be filled with an adhesive. In the method of manufacturing disclosed in the present specification, by appropriately selecting the size of the crimp protrusion, an appropriate gap is left between the electromagnetic steel sheets after crimp-fastening.

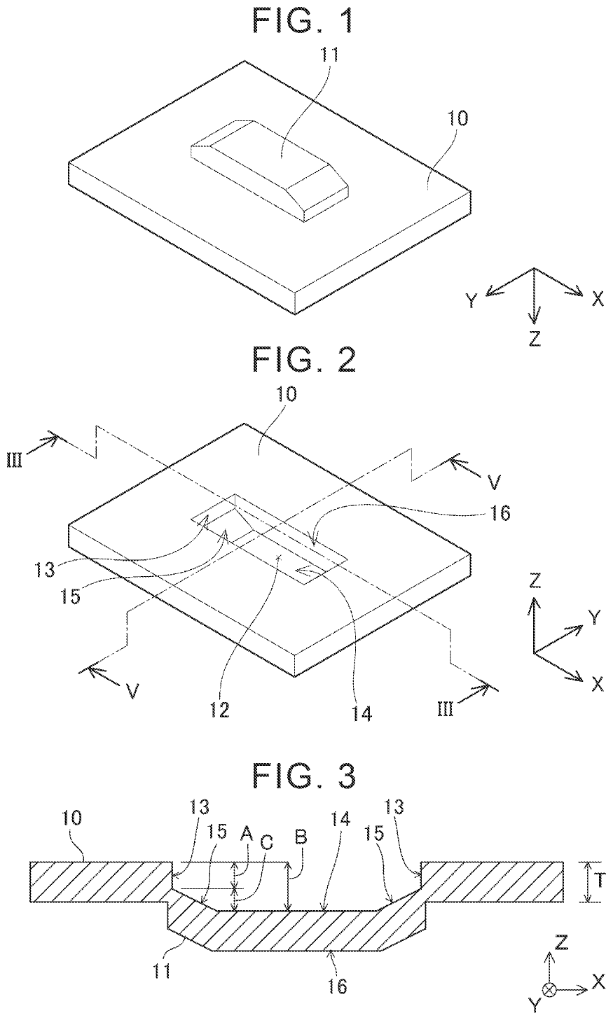

The method of manufacturing of the embodiment includes (1) protrusion providing step, (2) crimping step, and (3) filling step. In the protrusion providing step, a crimp protrusion is formed on the flat electromagnetic steel sheet. FIGS. 1 and 2 are perspective views of one electromagnetic steel sheet 10 on which a crimp protrusion 11 is formed. The electromagnetic steel sheet used in the motor core has a thickness of approximately 0.05 to 0.2 mm. In FIGS. 1 and 2, and in the following figures as well, the thickness of the electromagnetic steel sheet is exaggerated in order to facilitate understanding. A typical material of the electromagnetic steel sheet is a Fe—Co alloy.

In the present embodiment, a process of forming the crimp protrusion 11 (protrusion providing step) and an operation of the crimp protrusion 11 will be described in detail. The electromagnetic steel sheet 10 has an outer shape equal to the contour of the section of the motor core. The outer shape of the electromagnetic steel sheet 10 is not shown. In the figure, the outer shape of the electromagnetic steel sheet 10 is very simplified and is shown in a rectangular shape.

FIG. 2 is a reversed view of the electromagnetic steel sheet 10 of FIG. 1. A crimp protrusion 11 is formed on one surface of the electromagnetic steel sheet 10 (FIG. 1). When viewed from the side of the other surface, it can be seen that the inside of the crimp protrusion 11 is hollow (FIG. 2). The hollow portion inside the crimp protrusion 11 is referred to as a hollow portion 12.

The crimp protrusion 11 has a rectangular shape in a plan view of the electromagnetic steel sheet 10. The X direction of the coordinate system in the drawing corresponds to the longitudinal direction of the crimp protrusion 11. The Y direction of the coordinate system in the drawing corresponds to the lateral direction of the crimp protrusion 11. Sizing of the crimp protrusion 11, for example, the longitudinal length is about 2.5 to 6.0 mm. The lateral length is about 0.5 to 2.0 mm. The height of the crimp protrusion 11 is about 2.4T from 2.2T. Note that the symbol T indicates the thickness of the electromagnetic steel sheet 10. In the longitudinal direction, an inclined surface is formed between the side surface and the upper surface of the crimp protrusion 11. For convenience of explanation, the Z direction of the coordinate system in the drawing is referred to as the sheet thickness direction (of the electromagnetic steel sheet).

FIG. 3 is a sectional view of the electromagnetic steel sheet 10 taken along line III-III in FIG. 2. With reference to FIGS. 2 and 3, the shape of the hollow portion 12 will be described. The hollow portion 12 has a shape similar to the outer shape of the crimp protrusion 11. The inside of the crimp protrusion 11 (hollow portion 12) is surrounded by a side surface 13 and a side surface 16 perpendicular to the surface of the electromagnetic steel sheet 10, a bottom surface 14 parallel to the surface, and an inclined surface 15 connecting the side surface 13 and the bottom surface 14. The top surface 17 of the crimp protrusion 11 is a plane parallel to the surface of the electromagnetic steel sheet 10. The bottom surface 14 is a plane parallel to the top surface 17. That is, the bottom surface 14 is parallel to the surface of the electromagnetic steel sheet 10. For convenience of explanation, the rear side of the top surface 17 of the crimp protrusion 11 is referred to as a “bottom surface 14”. Based on the viewpoint in which the orientation in FIG. 3 is upside down, the “bottom surface” may be referred to as the “ceiling surface of the hollow portion 12 of the crimp protrusion 11”.

The inclined surface 15 connects the side surface 13 and the bottom surface 14 that intersect the longitudinal direction (X-axis) of the crimp protrusion 11. The inclined surface 15 is inclined so that the hollow portion 12 becomes narrower toward the bottom surface 14 from the side surface 13 along the sheet thickness direction (Z-axis). The side surface 16 intersecting the lateral direction (Y-axis) of the crimp protrusion 11 is orthogonal to the bottom surface 14 (see FIG. 2). In other words, there is no inclined surface between the side surface 16 and the bottom surface 14.

The dimensions of each surface forming the hollow portion 12 will be described. The depth (side surface depth A) along the side surface 13 of the electromagnetic steel sheet 10, the depth (bottom surface depth B) from the surface (the surface on the side where the opening of the hollow portion 12 is located) to the bottom surface 14, and the sheet thickness T of the electromagnetic steel sheet 10 satisfy the following (Equation 1) to (Equation 3). In other words, the bottom surface depth B is a length from the edge of the opening of the hollow portion 12 along the sheet thickness direction (Z-axis) to the bottom surface 14. The side surface depth A is the length of the side surface 13 along the sheet thickness direction (Z-axis). As described above, the “bottom surface” may be referred to as a “ceiling surface”. In this case, the “depth” may be referred to as “height”.

1.2T≤B≤1.4T (Equation 1)

0.0T<A<1.4T (Equation 2)

A<B (Equation 3)

When the (Equation 1) to (Equation 3) are satisfied, as will be described later, when a load is applied by laminating a plurality of electromagnetic steel sheets in a crimping step, an appropriate gap remains between adjacent electromagnetic steel sheets 10. Adhesive is injected into the gap. Conditions of (Equation 1) to (Equation 3) were derived from studies by the inventors. The depth C from one end to the other end of the inclined surface 15 along the sheet thickness direction (Z-axis) is represented by C=B−A (see FIG. 3).

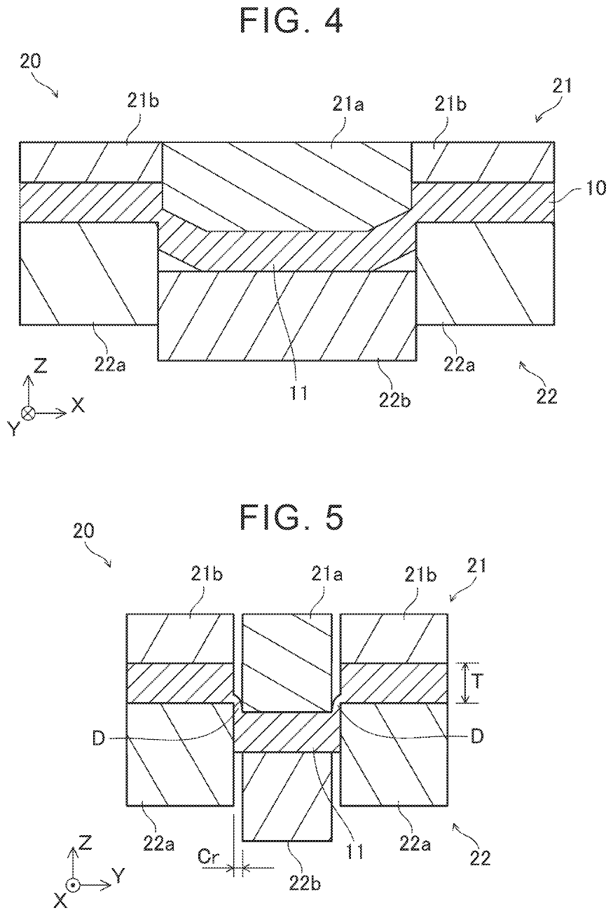

The protrusion providing step will be described with reference to FIGS. 4 and 5. The crimp protrusion 11 is formed by the press machine 20. FIGS. 4 and 5 show a state in which the electromagnetic steel sheet 10 is sandwiched by the press machine 20 and the crimp protrusion 11 is formed. FIG. 4 shows a section corresponding to the position of line III-III in FIG. 2. FIG. 5 shows a section corresponding to the position of V-V line of FIG. 2.

The press machine 20 includes an upper die 21 and a die 22. The upper die 21 moves up and down with respect to the die 22. The upper die 21 includes a punch 21a and a stripper 21b. The punch 21a can move up and down relative to the stripper 21b. The shape of the punch 21a is equal to the shape of the hollow portion 12.

The die 22 comprises a fixed die 22a and a movable die 22b. The movable die 22b is movable up and down relative to the fixed die 22a. The movable die 22b is positioned below the fixed die 22a so as to form the crimp protrusion 11. The flat electromagnetic steel sheet 10 is sandwiched between the upper die 21 and the die 22. Thereafter, the punch 21a is lowered. The electromagnetic steel sheet 10 is plastically deformed along the outer shape of the punch 21a. As a result, the crimp protrusion 11 is formed. While the electromagnetic steel sheet 10 is suppressed by the stripper 21b, the punch 21a is raised. Then, the upper die 21 is raised. When the movable die 22b is raised, the electromagnetic steel sheet 10 on which the crimp protrusion 11 is formed can be taken out from the press machine 20.

As shown in FIG. 5, a clearance Cr is provided between the fixed die 22a and the crimp protrusion 11. The clearance Cr is set generally between 0.03T and 0.06T. As described above, in the drawing, the sheet thickness T of the electromagnetic steel sheet 10 is exaggerated (thicker than the actual thickness). Therefore, the base of the crimp protrusion 11 (a portion indicated by reference numeral D in FIG. 5) is drawn thinner than the sheet thickness T. However, in practice, the thickness of the portion indicated by reference numeral D is substantially the same as the sheet thickness T.

A crimp protrusion 11 is formed on the plurality of electromagnetic steel sheets 10. A crimp protrusion 11 having the same shape and the same size is formed at the same position of the plurality of electromagnetic steel sheets 10.

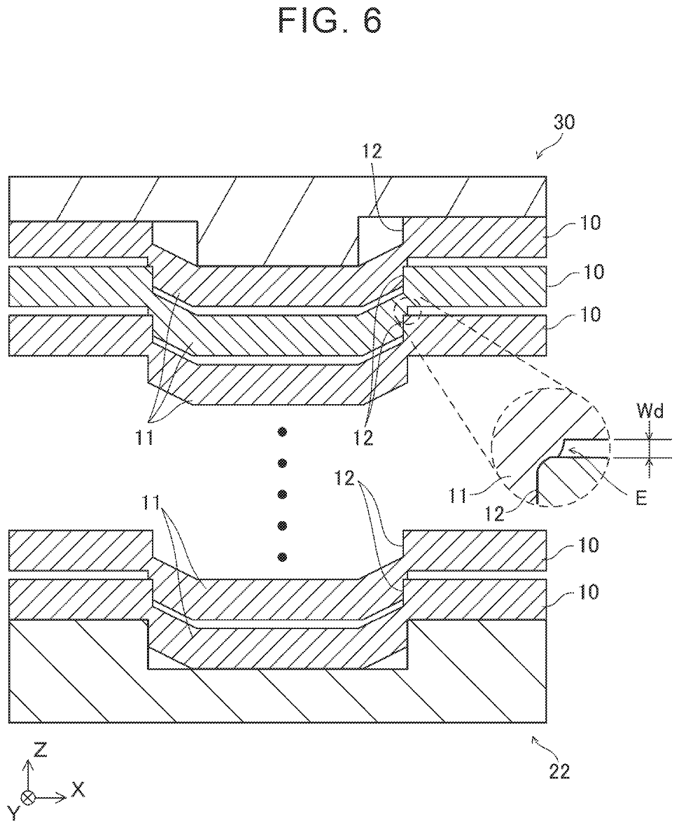

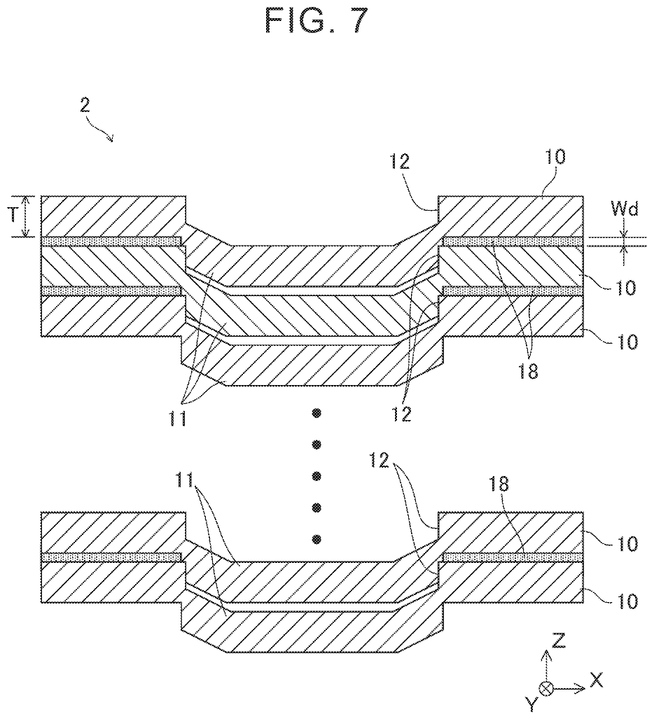

Next, the crimping step and the filling step will be described with reference to FIGS. 6 and 7. In the crimping step, a plurality of electromagnetic steel sheets 10 are laminated and a load is applied along the laminating direction. A plurality of laminated electromagnetic steel sheets 10 are set in the pressurizing device 30, and a load is applied in the laminating direction. The plurality of electromagnetic steel sheets 10 are laminated with the crimp protrusion 11 oriented in the same direction. As described above, the outer diameter of the crimp protrusion 11 is slightly larger than the inner diameter. The crimp protrusion 11 is fitted into the hollow portion 12 of the crimp protrusion 11 of the adjacent electromagnetic steel sheet 10. When a load is applied in the laminating direction, the crimp protrusion 11 is strongly fitted into the hollow portion 12 of the adjacent crimp protrusion 11 while being plastically deformed.

FIG. 6 also shows an enlarged view of a range surrounded by a dotted line. The area surrounded by the dotted line is the base of the crimp protrusion 11. The outer diameter of the crimp protrusion 11 is slightly larger than the inner diameter. When the crimp protrusion 11 is pushed into the hollow portion 12, the crimp protrusion 11 is distorted and plastically deformed. The base of the crimp protrusion 11 bulges outward (a portion indicated by reference numeral E in FIG. 6). The swelling at the base of the crimp protrusion 11 serves as a spacer. A gap in the width Wd is left between adjacent electromagnetic steel sheets 10. Conversely, the load is adjusted so that a gap in the width Wd remains between adjacent electromagnetic steel sheets 10. When the conditions of (Equation 1) to (Equation 3) are satisfied, the width Wd is about 0.05 to 0.1 mm. As described above, the thickness of the electromagnetic steel sheet 10 is exaggerated in the drawing. The width Wd of the gap is approximately T≥Wd≥(T/2).

The width Wd of the gap is suitably sized to fill the adhesive. When the conditions of (Equation 1) to (Equation 3) are satisfied, it is possible to leave a gap having a width suitable for filling an adhesive between adjacent electromagnetic steel sheets 10 in the crimping step.

Adjacent crimp protrusions 11 are connected to each other in all of the electromagnetic steel sheets 10. A gap in the width Wd is formed between adjacent electromagnetic steel sheets 10. In the filling step, the gap is filled with the adhesive 18 (FIG. 7). When the adhesive 18 solidifies, the motor core 2 is completed (FIG. 2). In the motor core 2, adjacent electromagnetic steel sheets 10 are strongly connected to each other by crimp bonding and adhesive. According to the method of manufacturing of the embodiment, it is possible to manufacture a motor core in which the connection of adjacent electromagnetic steel sheets is strengthened by adhesion.

Attentions regarding the techniques described in the examples are described below. The crimp protrusion 11 has a rectangular shape when the electromagnetic steel sheet 10 is viewed in plan. The inclined surface 15 facing the hollow portion 12 is formed between the side surface 13 and the bottom surface 14 intersecting the longitudinal direction (X-axis) of the crimp protrusion 11. There is no inclined surface between the side surface 16 and the bottom surface 14 intersecting the lateral direction (Y-axis) of the crimp protrusion 11.

A clearance Cr is provided between the end of the crimp protrusion 11 in the lateral direction (Y-axis) and the fixed die 22a (FIG. 5). A clearance Cr may or need not be provided between the longitudinal direction (X-axis) end of the crimp protrusion 11 and the fixed die 22a.

Although specific examples of the present disclosure have been described in detail above, these are merely examples. The above embodiments do not limit the scope of the claims. The techniques described in the claims include various modifications and alterations of the specific examples illustrated above. The technical elements described in this specification or in the drawings may be used alone or in various combinations. The technical elements described in this specification or in the drawings are not limited to the combinations claimed at the time of filing. Further, the technology illustrated in the present specification or the drawings can achieve a plurality of objects at the same time. By achieving one of the objects, the technology illustrated in the present specification or the drawings has technical usefulness.

What is claimed is:

1. A method of manufacturing a motor core, the method comprising:
a protrusion providing step of providing a hollow crimp protrusion in each of a plurality of electromagnetic steel sheets;
a crimping step in which the electromagnetic steel sheets are laminated to apply a load along a laminating direction, and in which the crimp protrusion of each of the adjacent electromagnetic steel sheets is crimp-fastened; and
a filling step of filling an adhesive between the adjacent electromagnetic steel sheets, wherein
a hollow portion inside the crimp protrusion includes a side surface perpendicular to a surface of each of the electromagnetic steel sheets, a bottom surface parallel to the surface of each of the electromagnetic steel sheets, and an inclined surface connecting the side surface and the bottom surface, and
a depth A along the side surface of the hollow portion, a depth B to the bottom surface, and a sheet thickness T of each of the electromagnetic steel sheets satisfy the following (Equation 1) to (Equation 3),
1.2T≤B≤1.4T (Equation 1)
0.0T<A<1.4T (Equation 2)
A<B (Equation 3).
